(19) United States
(12) Patent Application Publication
(10) Pub. No.: US 2009/0198412 A1
(43) Pub. Date: Aug. 6, 2009

(54) Vehicle-to-vehicle communications apparatus

(75) Inventor: Hidenao Shiraki, Ogaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/319,821

(22) Filed: Jan. 13, 2009

(30) Foreign Application Priority Data
Feb. 4, 2008 (JP) 2008-24093

(51) Int. Cl. G01C 19/00

(52) U.S. Cl. 701/36

(57) ABSTRACT

In a vehicle-to-vehicle communications apparatus mounted in a subject vehicle, the intersection nearest to the subject vehicle is obtained among intersections which exist in the heading direction of the subject vehicle. The intersection nearest to a peripheral vehicle is obtained among intersections which exist in the heading direction of the peripheral vehicle. When both the above intersections are identical to each other, a transmission cycle is shortened in the vehicle-to-vehicle communications apparatus of the subject vehicle. In contrast, when both are not identical, the transmission cycle is not changed. Such a configuration enables each of multiple vehicles to recognize mutual existence at an early stage when the vehicles approach the same intersection at the same time. Further, such a configuration helps prevent useless communications traffics from arising when only one vehicle approaches an intersection.

### CROSS REFERENCE TO RELATED APPLICATION

This application is based on and incorporates herein by reference Japanese Patent Application No. 2008-24093 filed on Feb. 4, 2008.

### FIELD OF THE INVENTION

The present invention relates to a vehicle-to-vehicle communications apparatus mounted in a vehicle, in order to communicate with other vehicles.

### BACKGROUND OF THE INVENTION

Patent Document 1: JP 2000-90395 A

A vehicle-to-vehicle communications apparatus is known which transmits the position and information of the subject vehicle to a peripheral vehicle, which is at a periphery of the subject vehicle, and receives the position and information of the peripheral vehicle. For example, Patent document 1 describes an apparatus for transmitting information on the subject vehicle with a shorter cycle as the subject vehicle travels at a higher speed and with a longer cycle as the subject vehicle travels at a lower speed.

When multiple vehicles approach the same intersection from the mutually different directions, the existence of the peripheral vehicle should be recognized as early as possible so as to avoid the danger. The apparatus in Patent document 1 is designed to lengthen the transmission cycle for information as the travel speed of the subject vehicle decreases. Thus, the recognition of the existence of the slowly traveling vehicle may be delayed in the peripheral vehicle. The state of the slowly traveling vehicle may be unable to be recognized correctly in the peripheral vehicle.

Further, multiple vehicles may separate from each other from the same intersection in the mutually different directions. In such a case, the information about the peripheral vehicles may be not so required; however, the apparatus in Patent document 1 is designed to still shorten the transmission cycle with respect to the vehicle traveling at a high speed to thereby increase the frequency unnecessarily. In other words, the useless communications traffics arise.

The above point is explained using FIGS. 13A, 13B. First, in FIG. 13A, the vehicles A, B, and C travel at low speeds to approach the same intersection in the mutually different directions. According to the apparatus in Patent document 1, the transmission cycles of the information in the vehicles A, B, and C become long. Accordingly, in the vehicles A, B, and C, the recognition of the mutual existence may be delayed. It may become impossible to grasp correctly the state of the corresponding peripheral vehicles in the vehicles A, B, and C.

Next, in FIG. 13B, the vehicles D to J separate from the same intersection. For instance, the group of vehicles D, E, and F, the group of the vehicles G and H, and the group of the vehicles I and J separate from each other group. In such a case, each group does not so require the information on other groups' vehicles. Supposing vehicles D to J run at high speeds (for example, 60 km/above). According to the apparatus in Patent document 1, the transmission cycle of the information in the vehicles D to J become short. Accordingly, the communications traffics are unnecessarily crowded. In addition, when a vehicle K approaches the intersection at a high speed, the information on the vehicle K is transmitted, with a short cycle, to other vehicles D to J separating from the vehicle K, resulting in useless transmission due to the same reason.

### SUMMARY OF THE INVENTION

It is an object to provide a technology to effectively perform transmission and reception of information on vehicles in vehicle-to-vehicle communications apparatuses.

As an example of the present invention, a vehicle-to-vehicle communications apparatus in a first vehicle is provided as follows. The apparatus is cooperative with another vehicle-to-vehicle communications apparatus in another vehicle. The vehicle-to-vehicle apparatus comprises the following: a transmission section configured to transmit information about the first vehicle to a second vehicle at a periphery of the first vehicle; a reception section configured to receive information about the second vehicle transmitted from the second vehicle; a transmission control section configured to control the transmission section; a first-vehicle approach intersection acquisition section configured to acquire first information on a nearest intersection from the first vehicle among intersections which exist in a heading direction of the first vehicle; a second-vehicle approach intersection acquisition section configured to acquire second information on a nearest intersection from the second vehicle among intersections which exist in a heading direction of the second vehicle from the information about the second vehicle received by the reception section; and a determination section configured to determine whether information about an identical intersection is included in the first information and the second information. Herein, the transmission control section is further configured to cause the transmission section to transmit information (i) with a cycle shorter than a predetermined cycle when it is determined that the information about the identical intersection is included and (ii) with a cycle longer than the predetermined cycle when it is determined that the information about the identical intersection is not included.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a configuration of an in-vehicle apparatus according to a first embodiment of the present invention;

FIG. 2 is a block diagram showing an overall configuration of a navigation system according to the first embodiment;

FIG. 3 is a flowchart illustrating a transmission cycle adjustment process executed in an information determination section of the in-vehicle apparatus according to the first embodiment;

FIG. 4 is a diagram for illustrating an operation according to the first embodiment;

FIG. 5 is a flowchart illustrating a transmission cycle adjustment process executed in an information determination section of the in-vehicle apparatus according to a second embodiment of the present invention;

FIG. 6 is a diagram for illustrating an operation according to the second embodiment;

FIG. 7 is a flowchart illustrating a transmission cycle adjustment process executed in the information determination section of the in-vehicle apparatus according to a third embodiment of the present invention;

FIG. 8 is a diagram for illustrating an operation according to the third embodiment;

FIG. 9 is a flowchart illustrating a transmission cycle adjustment process executed in the information determination section of the in-vehicle apparatus according to a fourth embodiment of the present invention;

FIG. 10 is a diagram for illustrating an operation according to the fourth embodiment;

FIG. 11 is a flowchart illustrating a transmission cycle adjustment process executed in the information determination section of the in-vehicle apparatus according to a fifth embodiment of the present invention;

FIG. 12 is a diagram for illustrating an operation according to the fifth embodiment; and

FIGS. 13A, 13B are diagrams for illustrating an operation in a conventional technology.

### DETAILED DESCRIPTION OF THE PREFERRED EMBODIMENTS

The following describes an embodiment of the present invention with reference to drawings.

### First Embodiment

The following describes a first embodiment of the present invention.

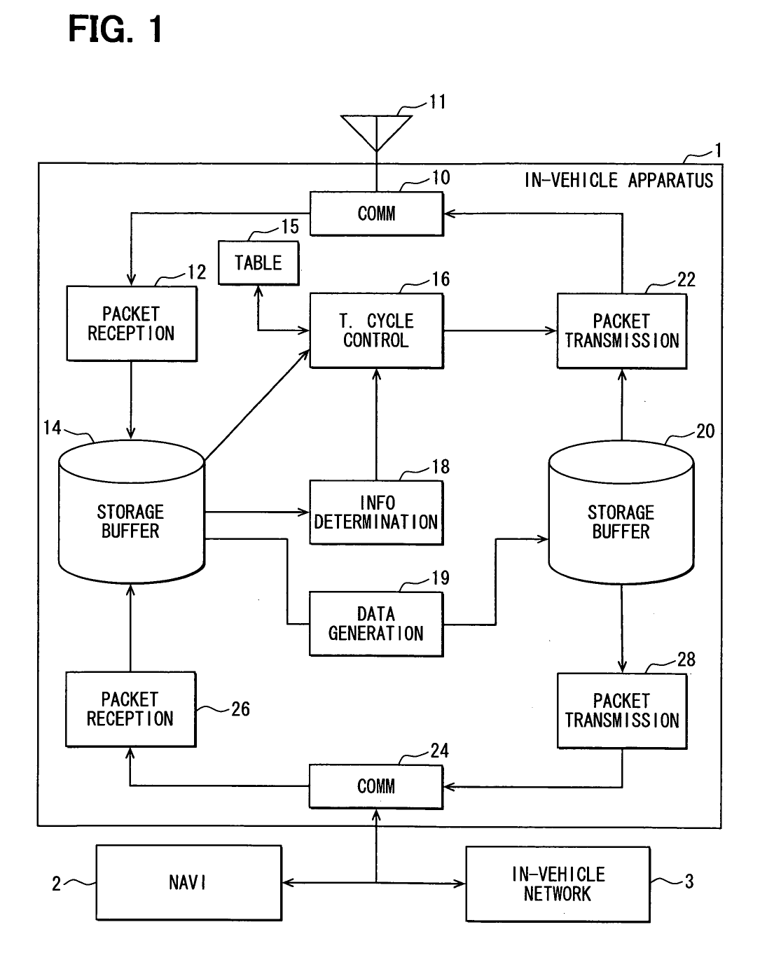

FIG. 1 is a block diagram showing a configuration of an in-vehicle apparatus 1 as a vehicle-to-vehicle communications apparatus according to an embodiment of the present invention. The in-vehicle apparatus 1 is mounted in a subject vehicle which is not illustrated. Further, the in-vehicle apparatus 1 in the subject vehicle communicates with another in-vehicle apparatus-1 mounted in another vehicle by vehicle-to-vehicle communications.

The in-vehicle apparatus 1 includes the following: a communication section 10 as a communication medium, an antenna 11, a packet reception section 12, a packet reception storage buffer 14, a table 15, a transmission cycle control section 16, an information determination section 18, a data generation section 19, a packet transmission storage buffer 20, a packet transmission section 22, a communication section 24 as a communication medium, a packet reception section 26, and a packet transmission section 28.

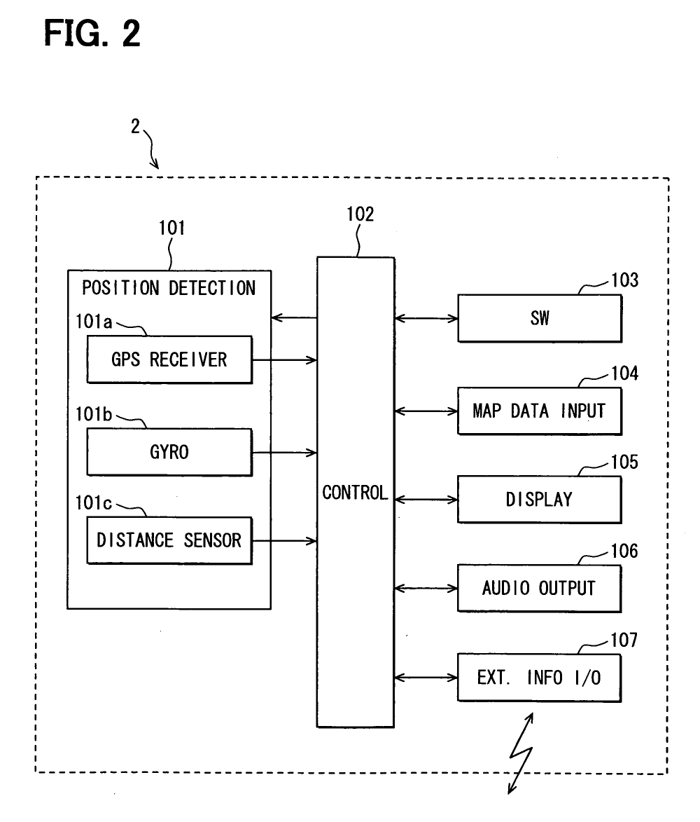

The in-vehicle apparatus 1 is connected with an in-vehicle network 3, for example, to communicate with a navigation system 2. FIG. 2 is a block diagram showing an overall configuration of the navigation system 2.

The navigation system 2 includes the following: a position detection section 101 to detect a present position of the subject vehicle, an operation switch group 103 to input various instructions from a user or driver, a map data input section 104 to input map data etc. from an outside storage medium recording map data and various kinds of information, a display section 105 to perform various displays of a map display, TV display, etc., an audio output section 106 to output various kinds of guidance audios, an external information I/O section 107, and a control section 102. The control section 102 executes various processes according to inputs from the position detection section 101, the operation switch group 103, the map data input section 104, and the external information I/O section 107. The control section 102 controls the position detection section 101, the operation switch group 103, the map data input section 104, the display section 105, the audio output section 106, and the external information I/O section 107.

The position detection section 101 includes the following sensors or the like: a GPS receiver 101a, which receives via a GPS antenna (not shown) electric waves from satellites for GPS (Global Positioning System) and is used for detecting a position, orientation, or speed of the vehicle; a gyroscope 101b which detects rotational movement exerted over the vehicle; and a distance sensor 101c which detects a travel distance of the vehicle. The individual sensors or the like 101a to 101c have different types of detection errors from each other; therefore, they are used to complement each other.

The operation switch group 103 includes a mechanical key switch arranged in the circumference of the display section 105 and a touch sensitive panel integrated into a surface of the screen on the display section 105. Here, the touch panel and the display section 105 are laminated integrally. In addition, although the touch panel includes various types to detect a user's manipulation such as a pressure-sensitive type, an electromagnetic induction type, a capacitive sensing type, or a type combining the foregoing, any type may be used in the present embodiment.

The map data input section 104 is used for inputting map data stored in a storage medium (unshown). The map data include link data for indicating roads, node data for indicating intersections, data for map matching to improve the positioning accuracy, mark data for indicating facilities, image data and audio data for guidance, etc. The storage medium for storing the above data includes a CD-ROM, DVD, hard disk, and various types of memory cards.

The display section 105 is a color display screen and can be a liquid crystal display, a plasma display, an organic electroluminescence display, a CRT, or the like. The display section 105 displays a map and associated data in superimposition in a display window. The associated data include a present position mark for indicating a present position of the vehicle, which is specified from a present position detected by the position detection section 101 and the map data inputted from the map data input section 104; a guidance route to a destination; names, landmarks, facility marks, and facility guidance.

The audio output section 106 can output sounds of guidance for facilities inputted from the map data input section 104, and read aloud sounds of information acquired via the external information 1/0 section 107.

The external information input/output section 107 transmits information to the in-vehicle network 3, or receives information from the in-vehicle network 3. In addition, the external information input/output section 107 receives FM broadcasting signals via a radio aerial (not illustrated), or radio wave beacon signals or optical beacon signals via a fixed station arranged near roads for servicing VICS (Vehicle Information and Communication System). The received information is sent to the control section 102 for processing. In addition, the external information input/output section 107 can also access the Internet.

The control section 102 includes a known microcomputer having a CPU, ROM, RAM, I/O, and a bus line connecting the foregoing components or the like. For example, based on each detection signal from the position detection section 101, a present position of the vehicle is calculated as a group of coordinates and a heading direction using program stored in the ROM or the like. The control section 102 displays, in the display section 105, a map near the present position. The map is read via the map data input section 104. Based on the point data stored in the map data input section 104, the control section 102 selects a destination according to operation via the operation switch group 103, and performs a route calculation to automatically obtain an optimal route from a present position to a destination.

Returning to FIG. 1, the in-vehicle apparatus 1 receives via the communication section 24 the present position, orientation, and speed of the vehicle calculated by the navigation system 2, and the peripheral map information also from the navigation system 2. In addition, information about the subject vehicle received via the communication section 24 from the navigation system 2 and in-vehicle network 3 is hereafter referred to as subject vehicle information. The in-vehicle apparatus 1 receives the subject vehicle information cyclically.

The subject vehicle information (packet information) received via the communication section 24 is sent to the packet reception section 26. The packet reception section 26 writes the subject vehicle information (packet information) in the packet reception storage buffer 14. Thereby, the subject vehicle information received from the navigation system 2 and the in-vehicle network 3 is accumulated in the packet reception storage buffer 14.

In addition, the in-vehicle apparatus 1 receives information about a peripheral vehicle (packet information) transmitted wirelessly from a peripheral vehicle, which runs at a periphery of the subject vehicle, via the antenna 11 and the communication section 10. The above information about the peripheral vehicle includes a present position, orientation, speed, and the like of the peripheral vehicle. In addition, the information about the peripheral vehicle received from the peripheral vehicle is hereafter referred to as peripheral vehicle information.

The peripheral vehicle information received via the antenna 11 and the communication section 10 is sent to the packet reception section 12. The packet reception section 12 writes the peripheral vehicle information (packet information) in the packet reception storage buffer 14. Thereby, the peripheral vehicle information received from the peripheral vehicle is accumulated in the packet reception storage buffer 14.

The data generation section 19 generates information (data) on the subject vehicle for transmitting to the peripheral vehicle based on the subject vehicle information accumulated in the packet reception storage buffer 14. The generated information is written in the packet transmission storage buffer 20. In addition, the data generation section 19 generates information (data) on the peripheral vehicle for transmitting to the navigation system 2 and the in-vehicle network 3 of the subject vehicle based on the peripheral vehicle information accumulated in the packet reception storage buffer 14. The generated information is written in the packet transmission storage buffer 20.

The packet transmission section 28 reads a predetermined information (information which should be transmitted to the navigation system 2 or the in-vehicle network 3) among the peripheral vehicle information accumulated in the packet transmission storage buffer 20. The read information is transmitted to the navigation system 2 or the in-vehicle network 3 via the communication section 24.

In contrast, the packet transmission section 22 reads the subject vehicle information accumulated in the packet transmission storage buffer 20. The read subject vehicle information is transmitted to a peripheral vehicle wirelessly via the communication section 10 and the antenna 11.

The transmission cycle control section 16 controls the transmission cycle of the packet transmission section 22. For instance, the information indicating the speed of the subject vehicle is read among the information accumulated in the packet reception storage buffer 14, and the transmission cycle is calculated based on the speed of the subject vehicle. Here, the transmission cycle is calculated with reference to the table 15 having the table information uniquely specifying the transmission cycle based on the speed. In addition, according to the table information of the table 15, the transmission cycle becomes short as the speed of the subject vehicle becomes large.

The transmission cycle control section 16 outputs to the packet transmission section 22 a transmission instruction for indicating that a transmission should be made using the calculated transmission cycle. The packet transmission section 22 transmits the subject vehicle information to a peripheral vehicle using the transmission cycle directed by the transmission cycle control section 16.

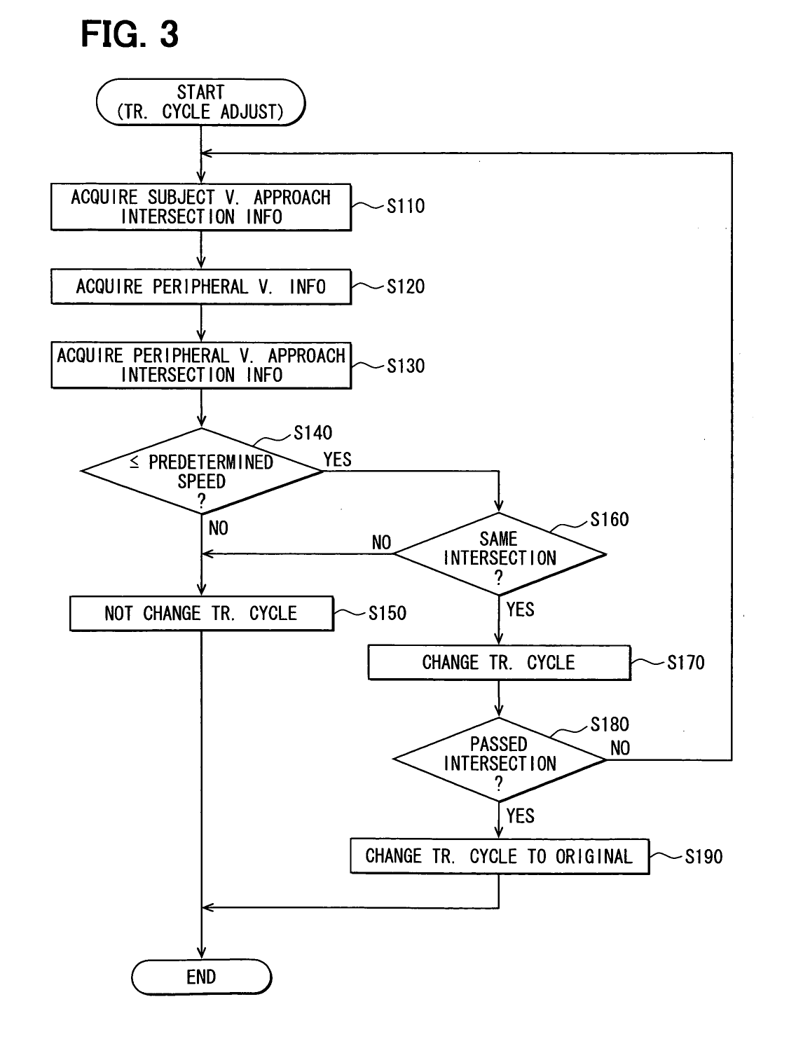

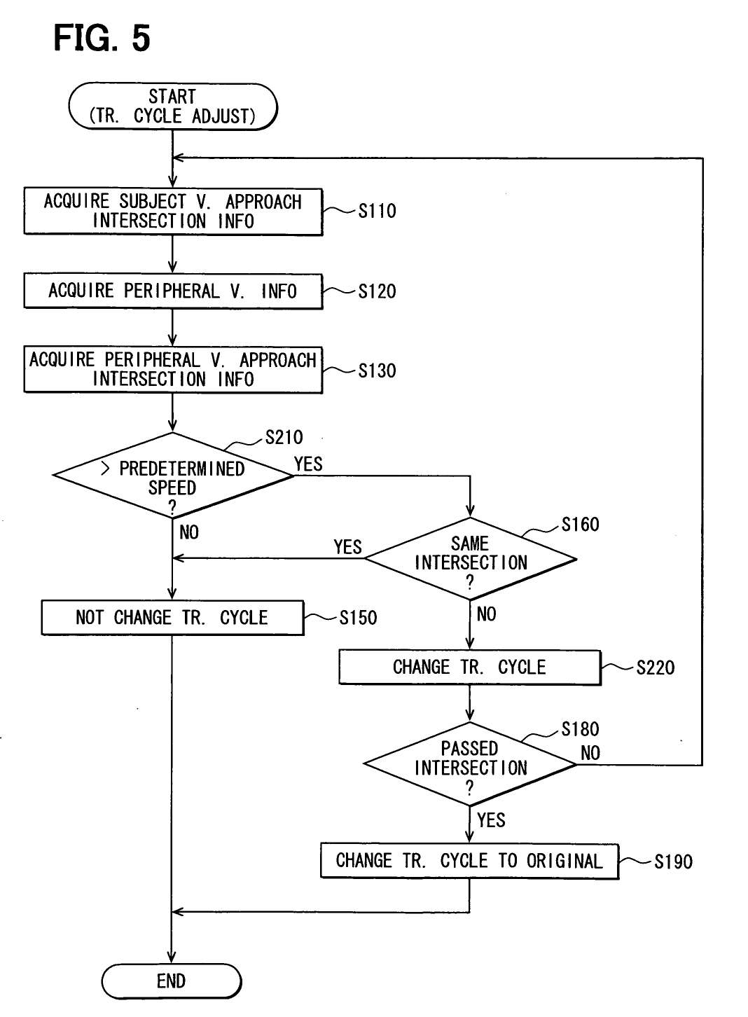

The information determination section 18 executes cyclically a transmission cycle adjustment process of FIG. 3 explained below. In addition, the information determination section 18 executes processes in FIGS. 5, 7, 9, and 11, which will be explained in the second to fifth embodiments later.

In the transmission cycle adjustment process of FIG. 3, at S110, the information (referred to as subject vehicle approach intersection information) indicating a nearest intersection, which is nearest to the subject vehicle, acquired from among intersections which exist in the heading direction of the subject vehicle based on the subject vehicle information accumulated in the packet reception storage buffer 14.

Next, at S120, peripheral vehicle information is acquired among the information accumulated in the packet reception storage buffer 14. As mentioned above, the peripheral vehicle information is received by the vehicle-to-vehicle communications (wireless communication) and accumulated in the packet reception storage buffer 14.

Next, at S130, based on the peripheral vehicle information acquired at S120, the information (referred to as peripheral vehicle approach intersection information) indicating a nearest intersection, which is nearest to the peripheral vehicle, is acquired among intersections which exist in the heading direction of the peripheral vehicle. Herein, the in-vehicle apparatus 1 acquires map data at a periphery of the present position of the peripheral vehicle from the navigation system 2. The information determination section 18 acquires the peripheral vehicle approach intersection information based on the map information. In addition, the navigation system 2 may transmit the peripheral vehicle approach intersection information to the in-vehicle apparatus 1.

Next, at S140, it is determined whether the speed of the subject vehicle is equal to or less than a predetermined speed. When it is determined that the speed is not equal to or less than a predetermined speed (S140: NO), the processing advances to S150. An instruction for indicating that the transmission cycle is not changed is outputted to the transmission cycle control section 16. In such a case, the contents of the transmission instruction from the transmission cycle control section 16 to the packet transmission section 22 are not changed. That is, the transmission cycle in the packet transmission section 22 is still the transmission cycle which is determined based on the speed of the subject vehicle.

In contrast, when it is determined that the speed of the subject vehicle is equal to or less than the predetermined speed (S140: YES), the processing advances to S160. Here, it is determined whether there is any information indicating the same intersection in the subject vehicle approach intersection information acquired at S110 and the peripheral vehicle approach intersection information acquired at S130. In other words, it is determined whether the peripheral vehicle approaches the intersection which the subject vehicle approaches.

When it is determined that there is no information indicating the same intersection at S160, i.e., when it is determined that the peripheral vehicle does not approach the intersection which the subject vehicle approaches (S160: NO), the processing advances to S150. In contrast, when it is determined that there is information indicating the same intersection at S160, i.e., when it is determined that the peripheral vehicle is approaching the intersection which the subject vehicle is approaching (S160: YES), the processing advances to S170. An instruction for indicating that the transmission cycle be changed is outputted to the transmission cycle control section 16. For instance, the instruction demands change into the transmission cycle, which is used when the speed of the subject vehicle is larger than the predetermined speed. That is, based on the determination that the subject vehicle and the peripheral vehicle both are approaching the same intersection, even when the speed of the subject vehicle is equal to or less than the predetermined speed, the transmission cycle of the subject vehicle information is changed to the shorter cycle, which is used when the speed of the subject vehicle is greater than the predetermined speed.

In addition, when there is information indicating the same intersection information at S160, the transmission cycle at S170 may be changed according to the number of the acquired information indicating the same intersection. For example, the transmission cycle is changed so that the transmission cycle when there is more information indicating the same intersection than a predetermined value is shorter than the transmission cycle when there is less information indicating the same intersection than the predetermined value. Thus, especially, when many peripheral vehicles are approaching the same intersection, the information on the subject vehicle can be promptly transmitted to other peripheral vehicles.

At S180, it is determined whether the subject vehicle has passed through the intersection (in detail, the intersection indicated by the subject vehicle approach intersection information). For instance, it is determined based on whether the subject vehicle approach intersection is changed. For example, when the subject vehicle approach intersection is changed, it is determined that the subject vehicle has passed through the previous subject vehicle approach intersection prior to the change.

When it is determined that the subject vehicle has not passed through the subject vehicle approach intersection at S180 (S180: NO), the processing returns to S110. In contrast, when it is determined that the subject vehicle has passed through the subject vehicle approach intersection (S180: YES), the processing advances to S190.

At S190, an instruction for indicating that the transmission cycle be changed to the previous value (or original value) is outputted to the transmission cycle control section 16. The previous value or original value is the value of the transmission cycle, which is determined based on the information on the table 15 when the speed of the subject vehicle is equal to or less than the predetermined speed. After S190, the process is then ended.

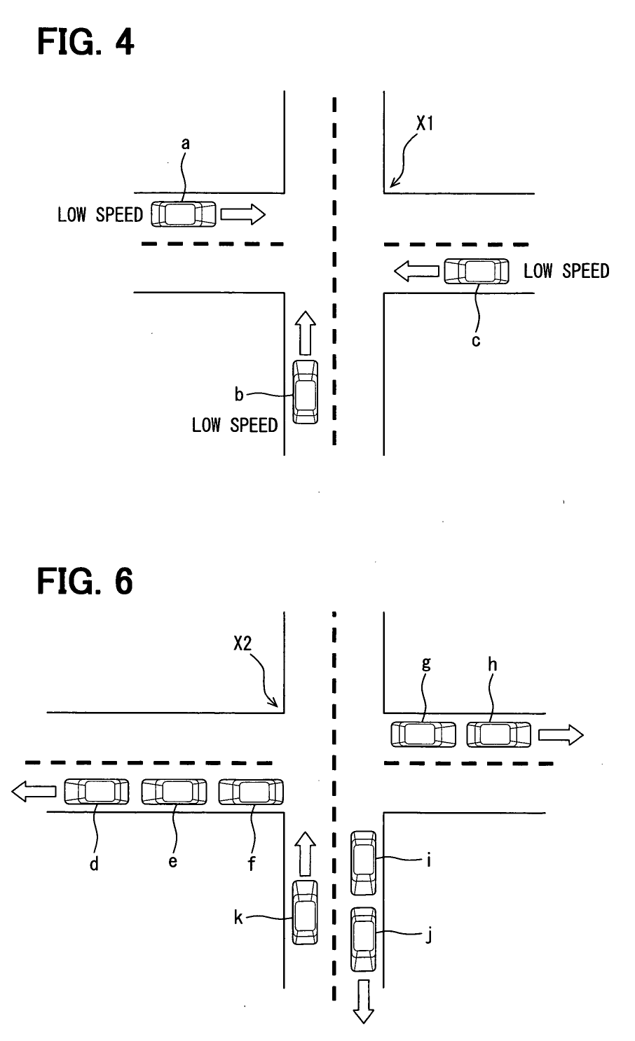

FIG. 4 illustrates an operation according to the first embodiment. In FIG. 4, vehicles a, b, and c are approaching the same intersection X1 at low speeds, individually. Each of the vehicles a, b, and c is provided with the in-vehicle apparatus 1 of the first embodiment. The mutual information is transmitted and received in the vehicles a, b, and c. In such a case, the transmission cycle of the in-vehicle apparatus 1 is as follows.

At each of the in-vehicle apparatuses 1 of the vehicles a, b, and c, the value of the transmission cycle is first obtained from the calculation as large values corresponding to the low speeds; namely, the transmission cycle is increased. For instance, the transmission cycle control section 16 acquires the transmission cycle in the case of the low speed with reference to the information on the table 15. The transmission cycle control section 16 instructs the packet transmission section 22 to transmit the information with the acquired transmission cycle.

In contrast, each of the in-vehicle apparatuses 1 of the vehicles a, b, and c acquires subject vehicle approach intersection information (indicating the intersection X1) at S110. In addition, periphery vehicle approach intersection information (indicating the intersection X1) is acquired at S120, S130. It is determined that the same information (indicating the intersection X1) is included in the acquired information (S160: YES). The transmission cycle is changed at S170. For instance, the transmission cycle is changed to be shorter.

Under such a configuration of the first embodiment, when the vehicles a, b, and c approach the same intersection X1 in the mutually different directions as illustrated in the example of FIG. 4, even if the speeds of the vehicles a, b, and c are low, the transmission cycles of the information in the in-vehicle apparatuses 1 are changed to be shorter. Accordingly, in each of the vehicles a, b, and c, the state of the peripheral vehicle(s) can be recognized with shorter time cycles. Accordingly, the state(s) of the peripheral vehicle(s) can be more correctly grasped now. In addition, in each of the vehicles a, b, and c, the existence of the peripheral vehicle(s) can be more certainly recognized at an earlier stage. Therefore, the safety improves more.

In the first embodiment, the packet transmission section 22 functions as an example of a transmission means or section. The packet reception section 12 and S120 by the information determination section 18 function as an example of a reception means or section. The transmission cycle control section 16, and S150 and S170 by the information determination section 18 function as an example of a transmission control means or section. S110 by the information determination section 18 functions as an example of a subject vehicle approach intersection acquisition means or section. S130 by the information determination section 18 functions as an example of a periphery vehicle approach intersection acquisition means or section. S160 by the information determination section 18 functions as an example of a determination means or section. The transmission cycle control section 16 functions as an example of a transmission cycle calculation means or section.

### Second Embodiment

The following describes a second embodiment.

The in-vehicle apparatus 1 of the second embodiment differs from that of the first embodiment in that the information determination section 18 executes the transmission cycle adjustment process in FIG. 5 instead of the transmission cycle adjustment process of FIG. 3. When Step of the transmission cycle adjustment process of FIG. 5 is the same as Step of the transmission cycle adjustment process of FIG. 3, such Step is assigned with an identical reference number. In addition, explanation is omitted suitably about the same Step.

In the transmission cycle adjustment process of FIG. 5, the processing advances to S210 after S130. At S210, it is determined whether the speed of the subject vehicle is greater than a predetermined speed. When it is determined that the speed is not greater than the predetermined speed (S210: NO), the processing advances to S150. An instruction for indicating that the transmission cycle be not changed is outputted to the transmission cycle control section 16.

In contrast, when it is determined that the speed of the subject vehicle is greater than the predetermined speed (S210: YES), the processing advances to S160. When it is determined that there is information indicating the same intersection (S160: YES), the processing advances to S150.

In contrast, when it is determined that there is not information indicating the same intersection (S160: NO), the processing advances to S220. Herein, an instruction for indicating that the transmission cycle be changed is outputted to the transmission cycle control section 16. For instance, the instruction demands change into the transmission cycle, which is used when the speed of the subject vehicle is equal to or less than the predetermined speed. That is, based on the determination that a peripheral vehicle does not approach the intersection which the subject vehicle approaches, even when the speed of the subject vehicle is greater than the predetermined speed, the transmission cycle of the subject vehicle information is changed to the longer cycle, which is used when the speed of the subject vehicle is equal to or less than the predetermined speed.

At S180 after S220, it is determined whether the subject vehicle has passed through the intersection. When it is determined that the subject vehicle has passed through the intersection (S180: YES), the processing advances to S190. At S190, an instruction for indicating that the transmission cycle be changed to the previous or original value is outputted to the transmission cycle control section 16. Herein, the previous or original value means the value of the transmission cycle, which is determined based on the information on the table 15 when the speed of the subject vehicle is greater than the predetermined speed. After S190, the process is then ended.

Next, FIG. 6 illustrates an operation according to the second embodiment. In FIG. 6, the vehicles d to j are departing or separating from the intersection X2 while the vehicle k is approaching the intersection X2 at a high speed, for example.

In the in-vehicle apparatus 1 of the vehicle k, the value of the transmission cycle is first obtained from the calculation as a small value corresponding to the high speed; namely, the transmission cycle is decreased. For instance, the transmission cycle control section 16 acquires the transmission cycle corresponding to the high speed with reference to the information on the table 15. The transmission cycle control section 16 instructs the packet transmission section 22 to transmit the information with the acquired transmission cycle.

In contrast, the in-vehicle apparatus 1 of the vehicle k acquires subject vehicle approach intersection information (indicating the intersection X2) at S110. In addition, the periphery vehicle approach intersection information (indicating intersections other than the intersection X2) is acquired at S120, S130. When it is determined that there is no information indicating the same intersection (S160: NO), the transmission cycle is changed at S220. For instance, the transmission cycle is changed to be longer.

Under such a configuration of the second embodiment, as illustrated in the example of FIG. 6, when the vehicle k approaches the intersection X2 at a high speed and multiple vehicles d to j depart from the intersection X2, only the vehicle k is approaching the intersection X2. Thus, in the vehicle k, the transmission cycle of the information is increased. Accordingly, the useless communications traffics do not arise while the congestion of the communications traffics can be avoided. Thus, the vehicle-to-vehicle communications between the vehicles d to k can be made appropriately.

In addition, if the vehicles d to j run at low speeds, the transmission cycle of the information of each of the vehicles d to j is changed to be long based on the low speed. In this case, the communications traffics cease to be crowded.

### Third Embodiment

The following describes a third embodiment of the present invention.

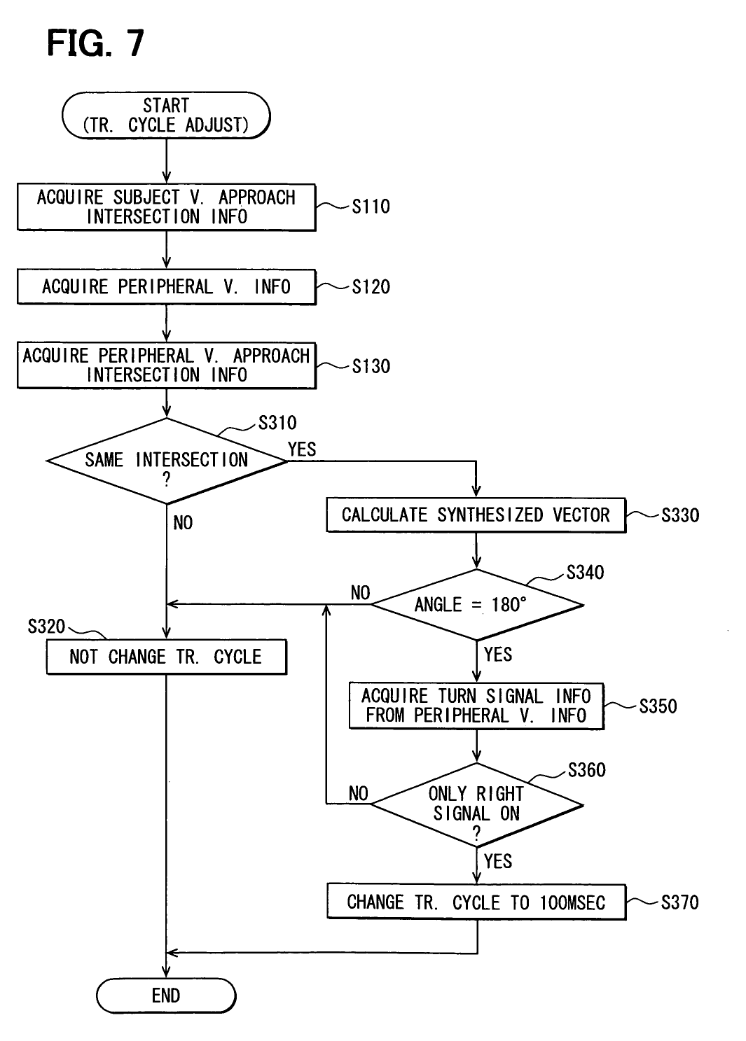

The in-vehicle apparatus 1 of the third embodiment differs from that of the first embodiment in that the information determination section 18 executes the transmission cycle adjustment process in FIG. 7 instead of the transmission cycle adjustment process of FIG. 3.

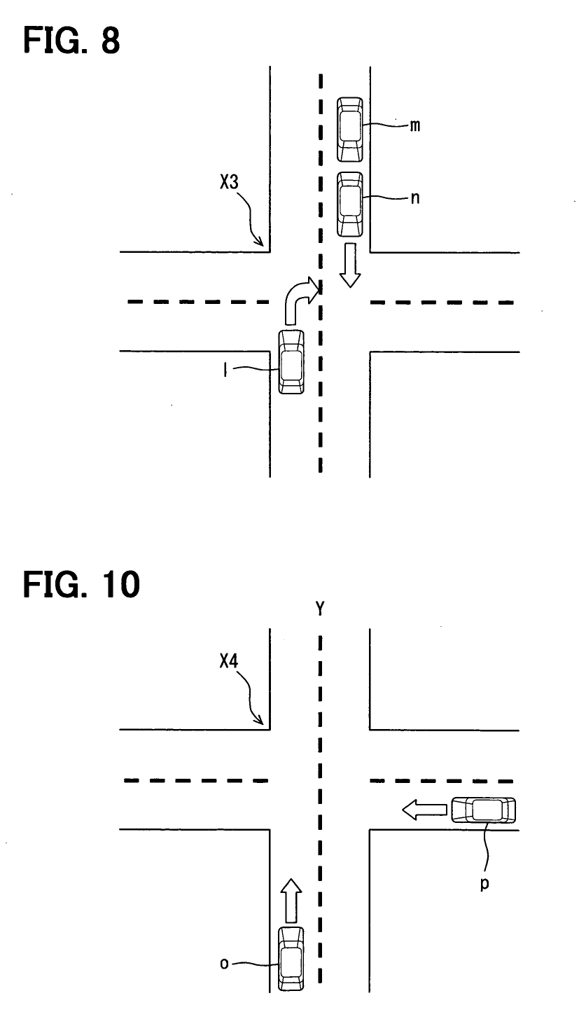

As illustrated in FIG. 8 mentioned later, the following is assumed to occur. That is, two vehicles n, m approaching the same intersection X3 is about to go straight while one vehicle 1 is about to turn right at the same intersection X3. In such a case, the third embodiment aims to improve the safety. When Step of the transmission cycle adjustment process of FIG. 7 is the same as Step of the transmission cycle adjustment process of FIG. 3, such Step is assigned with an identical reference number. In addition, explanation is omitted suitably about the same Step. In addition, in the third embodiment, the variable range of the transmission cycle is assumed to be 100 to 2000 msec.

In the transmission cycle adjustment process of FIG. 7, at S310 after S130, it is determined whether there is any information indicating the same intersection in the subject vehicle approach intersection information acquired at S110 and the peripheral vehicle approach intersection information acquired at S120, S130. When it is determined that there is not information indicating the same intersection (S310: NO), the processing advances to S320.

At S320, an instruction for indicating that the transmission cycle be not changed is outputted to the transmission cycle control section 16. After S320, the process is then ended. In contrast, when it is determined that there is information indicating the same intersection (S310: YES), the processing advances to S330. Herein, calculation is made for obtaining a vector showing the heading direction and speed of the subject vehicle, and a vector showing the heading direction and speed of the peripheral vehicle approaching the same intersection approached by the subject vehicle. A synthesized vector of the two calculated vectors is then calculated. In other words, the angle which the two calculated vectors make is calculated. That is, the relative relation between the heading direction and speed of the subject vehicle, and the heading direction and speed of the peripheral vehicle is calculated.

At S340 after S330, it is determined whether the synthesized vector calculated at S330 is 180 degrees. For instance, it is determined whether the subject vehicle and the peripheral vehicle are approaching each other along the same path in the opposite directions.

When the synthesized vector is determined not to be 180 degrees, i.e., when it is determined that the subject vehicle and the peripheral vehicle are not approaching each other along the same path in the opposite directions (S340: NO), the processing advances to S320.

In contrast, when the synthesized vector is determined to be 180 degrees, i.e., when it is determined that the subject vehicle and the peripheral vehicle are approaching each other along the same path in the opposite directions (S340: YES), the processing advances to S350.

At S350, turn signal information is acquired from the peripheral vehicle information acquired at S120. The turn signal information is to indicate whether the turn signal is operated in the peripheral vehicle. Next, at S360, it is determined at S350 whether the turn signal on the right of the peripheral vehicle operates based on the turn signal information acquired (in detail, whether the left turn signal does not operate but only the right signal operates).

When it is determined that only the right turn signal does not operate at S360, e.g., when it is determined that only the left turn signal operates or both the right and left turn signals operate (S360: NO), the processing advances to S320.

In contrast, when it is determined that only the right turn signal operates (S360: YES), the processing advances to S370. At S370, an instruction for indicating that the transmission cycle be changed to 100 msec is outputted to the transmission cycle control section 16. This is to shorten the transmission cycle as possible. The transmission cycle control section 16 controls the packet transmission section 22 so that the information is transmitted with the transmission cycle (100 msec) demanded by the information determination section 18. In addition, a value of 100 msec is an example. The transmission cycle can be variable in the range of 100 to 2000 msec as long as it satisfies the required transmission frequency.

FIG. 8 is a diagram for illustrating an operation according to the third embodiment. In FIG. 8, the vehicle 1 and the vehicles m, n are approaching the intersection X3 in the same path while opposing each other. The vehicles m and n run the road from the top to the bottom in FIG. 8 while the vehicle 1 runs from the bottom to the top in FIG. 8. In addition, the vehicle 1 is about to turn to the right at the intersection X3. In addition, the vehicle 1 turns on the right-turn signal for indicating the right turn although it is not illustrated in FIG. 8. The information indicating the operating state of the turn signal is transmitted to the vehicles m, n via the vehicle-to-vehicle communications.

Under such a state, in the vehicles m, n, the subject vehicle approach intersection information (indicating the intersection X3) is acquired at S110. In addition, the periphery vehicle approach intersection information (indicating the intersection X3) is acquired at S120, S130. Then, it is determined that there is same information (information indicating the intersection X3) in the acquired information (S310: YES). Herein, calculation is made for obtaining a vector showing the heading direction and speed of the subject vehicle, and a vector showing the heading direction and speed of the peripheral vehicle approaching the same intersection approached by the subject vehicle. A synthesized vector of the two calculated vectors is then calculated at S330.

It is then determined whether the calculated direction of the synthesized vector is 180 degrees in the vehicles m, n, i.e., whether the vehicles m, n and the vehicle 1 run opposite to each other in the same path at S340. In the example of FIG. 8, it is determined that the direction of the synthesized vector is 180 degrees (S340: YES).

In addition, in the vehicles m, n, the turn signal information is acquired from the information on the vehicle 1 received from the vehicle 1 at S350. It is determined that the right turn signal operates (S360: YES). Accordingly, it is determined that the vehicle 1 intends to turn to the right; thus, the transmission cycle is changed to be shorter (e.g., 100 msec) at S370.

In summary, the following are assumed in the third embodiment: (1) One party, i.e., the vehicles m, n, intends to go straight on at the intersection X3; and (2) The other party, i.e., the vehicle 1, intends to turn to the right at the intersection X3. In such a case, in the vehicle (vehicles m and n) which is going to go straight on, the transmission cycle of the information becomes short. The vehicle 1 which is going to turn to the right can recognize the existence of the vehicles m, n which are going to go straight on at an early stage. In addition, the vehicle 1 which is going to turn to the right can securely recognize the state of the vehicles m, n which are going to go straight on. Therefore, the safety improves more.

### Fourth Embodiment

The following describes a fourth embodiment of the present invention.

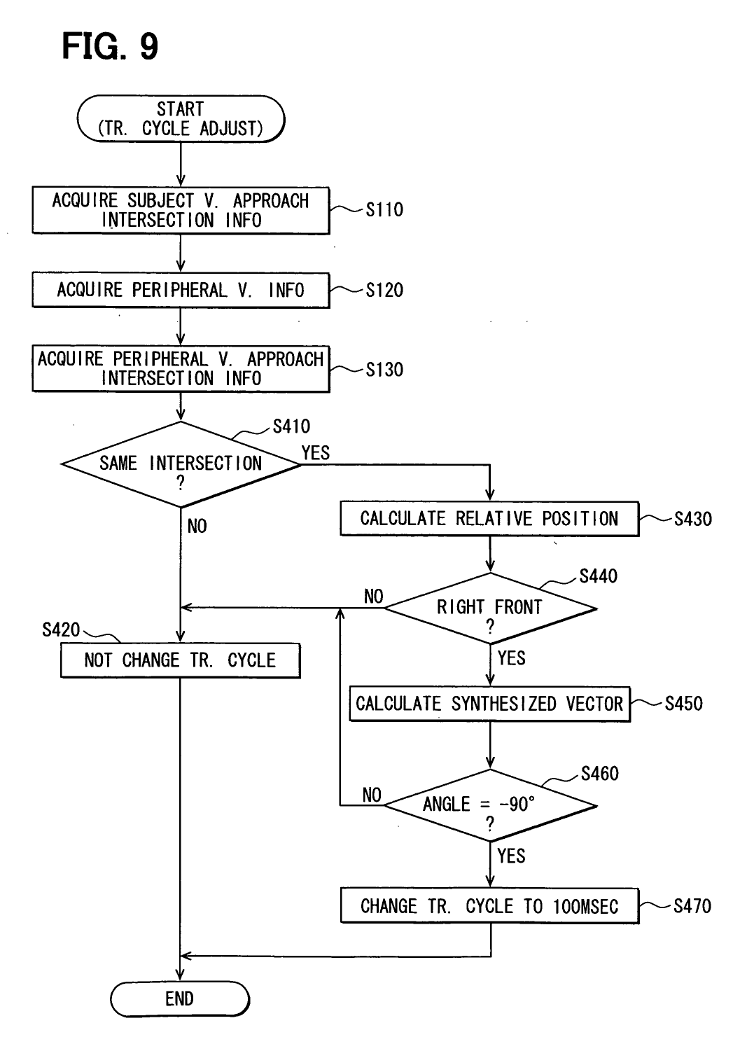

The in-vehicle apparatus 1 of the fourth embodiment differs from that of the first embodiment in that the information determination section 18 executes the transmission cycle adjustment process in FIG. 9 instead of the transmission cycle adjustment process of FIG. 3. As illustrated in FIG. 10 mentioned later, the following is assumed: the vehicles o, p individually approach the same intersection X4; and the vehicle p approaches the intersection X4 from a point right front of the vehicle o. In such a case, the fourth embodiment aims to improve the safety. When Step of the transmission cycle adjustment process of FIG. 9 is the same as Step of the transmission cycle adjustment process of FIG. 3, such Step is assigned with an identical reference number. In addition, explanation is omitted suitably about the same Step. In addition, in the fourth embodiment, the variable range of the transmission cycle is assumed to be 100 to 2000 msec.

In the transmission cycle adjustment process of FIG. 9, at S410 after S130, it is determined whether there is any information indicating the same intersection in the subject vehicle approach intersection information acquired at S110 and the peripheral vehicle approach intersection information acquired at S120, S130. When it is determined that there is not information indicating the same intersection (S410: NO), the processing advances to S420.

Herein, an instruction for indicating that the transmission cycle be not changed is outputted to the transmission cycle control section 16. After S420, the process is then ended. In contrast, when it is determined that there is information indicating the same intersection (S410: YES), the processing advances to S430. Herein, while acquiring the present position of the subject vehicle, and the present position of the peripheral vehicle, a relative position of the subject vehicle and the peripheral vehicle is calculated. For instance, the information showing the present position of the subject vehicle is acquired from the information on the subject vehicle obtained from the navigation system 2. In addition, based on the information on the peripheral vehicle received from the peripheral vehicle via the vehicle-to-vehicle communications, the information showing the present position of the peripheral vehicle is acquired. The relative position therebetween is calculated based on the present position of the subject vehicle, and the present position of the peripheral vehicle.

Next, at S440, it is determined whether the relative position of the peripheral vehicle (position of the other party's vehicle) is right front of the subject vehicle. When it is determined that it is not right front (S440: NO), the processing advances to S420.

When it is determined that it is right front (S440: YES), the processing advances to S450. At S450, calculation is made for obtaining a vector showing the heading direction and speed of the subject vehicle, and a vector showing the heading direction and speed of the peripheral vehicle approaching the same intersection approached by the subject vehicle. A synthesized vector of the two calculated vectors is then calculated. In other words, the angle which the two calculated vectors make is calculated.

At S460, it is determined whether the angle formed by the two vectors calculated at S450 is −90 degrees. In other words, for example, on the assumption that the subject vehicle and the peripheral vehicle approach the same intersection, it is determined whether a peripheral vehicle is approaching from the right-hand point of a road intersected by the road the subject vehicle runs.

When it is determined that the angle formed by the vectors is not −90 degrees (S460: NO), the processing advances to S420. In contrast, when it is determined that the angle formed by the vectors is −90 degrees (S460: YES), the processing advances to S470. Herein, an instruction for indicating that the transmission cycle be changed to 100 msec is outputted to the transmission cycle control section 16. This aims to shorten the transmission cycle as possible. In addition, a value of 100 msec is an example. The transmission cycle can be variable in the range of 100 to 2000 msec as long as it satisfies the required transmission frequency.

FIG. 10 illustrates an operation according to the fourth embodiment. In FIG. 10, both the vehicles o, p are individually approaching the intersection X4. The vehicle o approaches the intersection X4 along a road from the bottom in FIG. 10 while the vehicle p approaches the intersection X4 along a road from the right. Herein, “front” signifies a heading direction of each of the vehicles o, p while “right” signifies a right side of the heading direction of each of the vehicles o, p. For example, in FIG. 10, the position of the vehicle p is located at a position right front of the vehicle o while, the point assigned with Y is located right front of the vehicle p.

Under such a state,

the vehicle o or the in-vehicle apparatus 1 of the vehicle o acquires subject vehicle approach intersection information (indicating the intersection X4) at S110. In addition, the periphery vehicle approach intersection information (indicating the intersection X4) is acquired at S120, S130. When it is determined that there is same information (information indicating the intersection X4) among the acquired information (S410: YES), the relative position of the vehicle o and the vehicle p is calculated at S430.

In the vehicle o, it is determined that the vehicle p is present in a point right front (S440: YES). Next, the vector showing the heading direction and speed of the subject vehicle (vehicle o) and the vector showing the heading direction and speed of the peripheral vehicle (vehicle p) are calculated. The synthesized vector (angle which the vectors make) of the two calculated vectors is calculated at S450. It is determined whether the angle which the vectors make is −90 degrees at S460. In the example of FIG. 10, it is determined that the angle formed by the vectors is −90 degrees (S460: YES). The transmission cycle is thus changed to be shorter (e.g., 100 msec) at S470.

Thus, in the case that multiple vehicles (vehicles o, p) individually run the roads intersecting each other while approaching the intersection of the roads, the transmission cycle of the information in the vehicle o becomes short. In the vehicle p, the existence of the vehicle o can be thereby recognized at an earlier stage. In addition, in the vehicle p, the state of the vehicle o can be more correctly recognized. Therefore, the safety improves more.

### Fifth Embodiment

The following describes a fifth embodiment of the present invention.

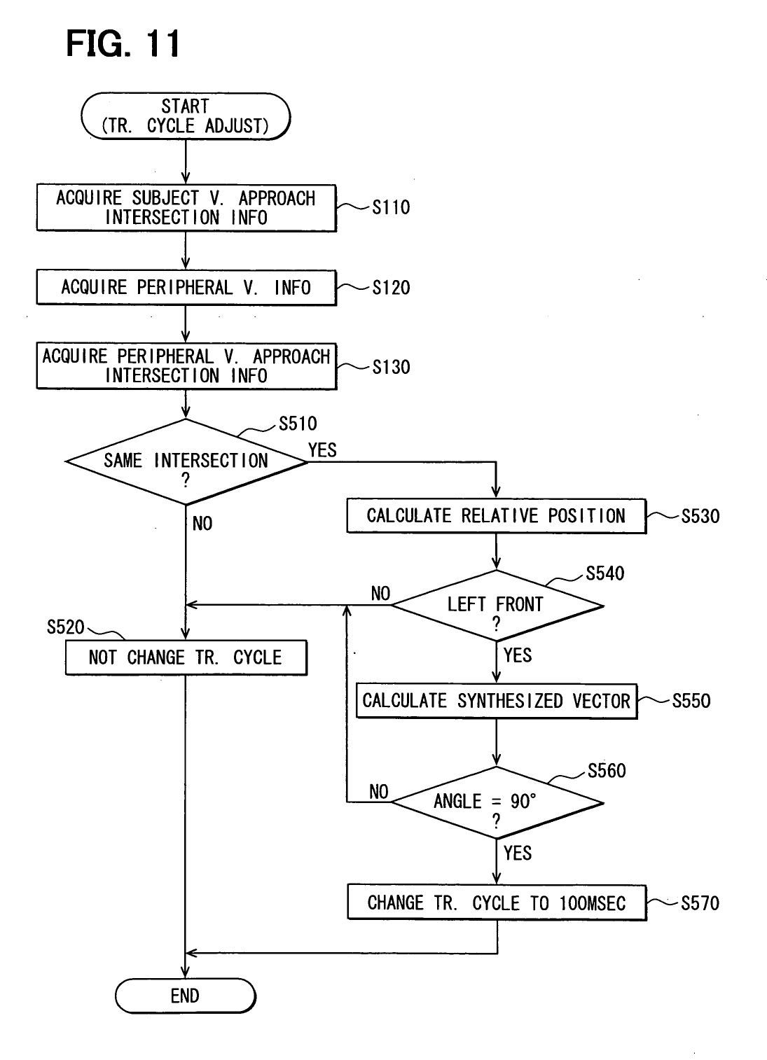

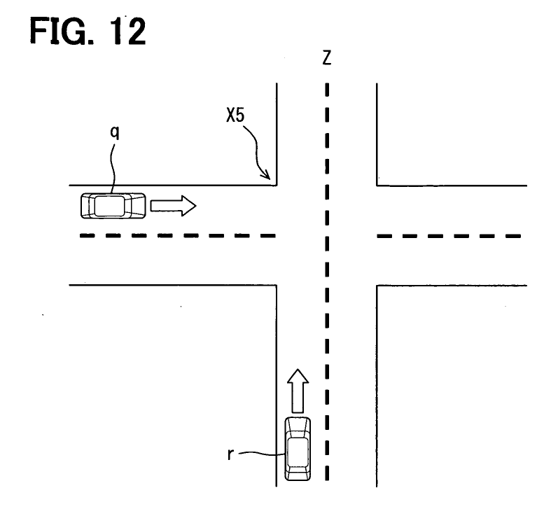

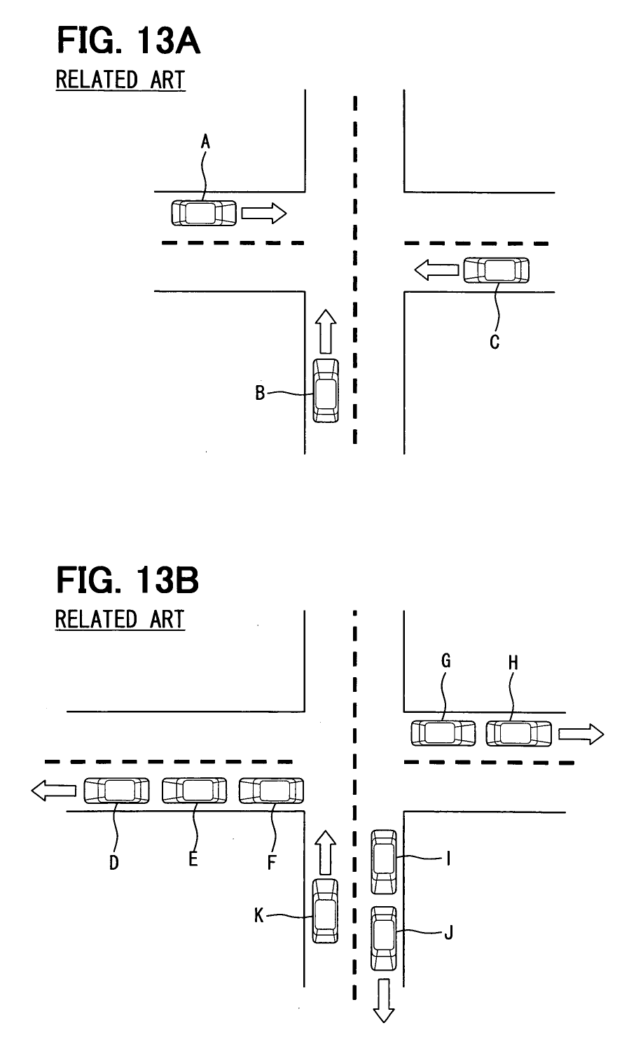

The in-vehicle apparatus 1 of the fifth embodiment differs from that of the first embodiment in that the information determination section 18 executes the transmission cycle adjustment process in FIG. 11 instead of the transmission cycle adjustment process of FIG. 3. As illustrate in FIG. 12 mentioned later, the vehicles q, r individually approach the same intersection X5; in particular, the vehicle q approaches the intersection X5 from the left front of the vehicle r. In such a case, the fifth embodiment aims to improve the safety. When Step of the transmission cycle adjustment process of FIG. 11 is the same as Step of the transmission cycle adjustment process of FIG. 3, such Step is assigned with an identical reference number. In addition, explanation is omitted suitably about the same Step. In addition, in the fifth embodiment, the variable range of the transmission cycle is assumed to be 100 to 2000 msec.

In the transmission cycle adjustment process of FIG. 11, at S510 after S130, it is determined whether there is any information indicating the same intersection in the subject vehicle approach intersection information acquired at S110 and the peripheral vehicle approach intersection information acquired at S120, S130. When it is determined that there is not information indicating the same intersection (S510: NO), the processing advances to S520.

Herein, an instruction for indicating that the transmission cycle be not changed is outputted to the transmission cycle control section 16. After S520, the process is then ended. In contrast, when it is determined that there is information indicating the same intersection (S510: YES), the processing advances to S530. Herein, while acquiring the present position of the subject vehicle, and the present position of the peripheral vehicle, a relative position of the subject vehicle and the peripheral vehicle is calculated.

Next, at S540, it is determined whether the relative position of the peripheral vehicle (position of the other party's vehicle) is left front of the subject vehicle. When it is determined that it is not left front (S540: NO), the processing advances to S520.

When it is determined that it is left front (S540: YES), the processing advances to S550. Herein, calculation is made for obtaining a vector showing the heading direction and speed of the subject vehicle, and a vector showing the heading direction and speed of the peripheral vehicle approaching the same intersection approached by the subject vehicle. A synthesized vector of the two calculated vectors is then calculated. In other words, the angle which the two calculated vectors make is calculated.

At S560, it is determined whether the angle formed by the two vectors calculated at S550 is 90 degrees. On the assumption that the subject vehicle and the peripheral vehicle approach the same intersection, it is determined whether a peripheral vehicle is approaching from the left-hand point of a road intersected by the road the subject vehicle runs.

When it is determined that the angle formed by the vector is not 90 degrees (S560: NO), the processing advances to S520. In contrast, when it is determined that the angle formed by the vector is 90 degrees (S560: YES), the processing advances to S570. At S570, an instruction for indicating that the transmission cycle be changed to 100 msec is outputted to the transmission cycle control section 16. This is to shorten the transmission cycle as possible. In addition, a value of 100 msec is an example. The transmission cycle can be variable in the range of 100 to 2000 msec as long as it satisfies the required transmission frequency. FIG. 12 illustrates an operation according to the fifth embodiment.

In FIG. 12, the vehicles q and r are individually approaching the intersection X5. The vehicle r approaches the intersection X5 along a road from the bottom in FIG. 12 while the vehicle q approaches the intersection X4 along a road from the left. Herein, “front” signifies a heading direction of each of the vehicles q, r while “left” signifies a left side of the heading direction of each of the vehicles q, r. For example, in FIG. 12, the position of the vehicle q is located at a position left front of the vehicle r, while the point assigned with Z is located left front of the vehicle q.

Under such a state, the vehicle r or the in-vehicle apparatus 1 of the vehicle r acquires subject vehicle approach intersection information (indicating the intersection X5) at S110. In addition, the periphery vehicle approach intersection information (indicating the intersection X5)is acquired at S120, S130. When it is determined that there is the same information (information showing the intersection X5) among the acquired information (S510: YES), the relative position of the vehicle r and the vehicle q is calculated at S530.

In the vehicle r, it is determined that the vehicle q is present in a point left front (S540: YES). Next, the vector showing the heading direction and speed of the subject vehicle (vehicle r) and the vector showing the heading direction and speed of the peripheral vehicle (vehicle q) are calculated. The synthesized vector (angle which the vectors make) of the two calculated vectors is calculated at S550. It is determined whether the angle which the vectors make is 90 degrees at S560. In the example of FIG. 12, it is determined that the angle formed by the vectors is 90 degrees (S560: YES). The transmission cycle is thus changed to be shorter (e.g., 100 msec) at S570.

For instance, in cases where multiple vehicles q, r approach the crisscross intersection along each of roads intersecting, the transmission cycle of the information in the vehicle r is changed to be shorter. In the vehicle q, the existence of the vehicle r can be thereby recognized at an earlier stage. In addition, in the vehicle q, the state of the vehicle r can be more correctly recognized. Therefore, the safety improves more.

(Modification 1)

Here, in the in-vehicle apparatus 1, the process of FIG. 9 according to the fourth embodiment and the process of FIG. 11 according to the fifth embodiment may be executed simultaneously.

According to such a configuration, for example, in both the vehicles o, p of FIG. 10 and in both the vehicles q, r of FIG. 11, the transmission cycle of the information becomes short, individually. The mutual existence comes to be recognized at an earlier stage more certainly. Accordingly, the state(s) of the peripheral vehicle(s) can be more correctly grasped now.

(Modification 2)

In addition, each of the above first to fifth embodiments can be modified as follows.

In the first to fifth embodiments, the transmission cycle is first calculated based on the speed of the subject vehicle; however, it is not necessary to prepare such a configuration. The transmission cycle may be calculated based on the result of the determination as to whether a peripheral vehicle also approaches the intersection which the subject vehicle approaches. For example, when the peripheral vehicle also approaches the intersection which the subject vehicle approaches, the transmission cycle may be shorter than the predetermined cycle. On the contrary, when a peripheral vehicle does not approach the intersection which the subject vehicle approaches, the transmission cycle may be longer than the predetermined cycle.

Up to this point, description has been given to an embodiment of the present invention. However, the present invention is not limited to the above embodiment, and it can be variously embodied without departing from the subject matter of the present invention. For example, although the transmission cycle according to the speed of the subject vehicle is calculated by referring to the information on the table 15, the transmission cycle may be acquired by a calculation.

In addition, in the process of FIGS. 7, 9, 11 of the above third to fifth embodiments, the information determination section 18 may execute the processing of S180, S190 in the process of FIGS. 3, 5 of the first and second embodiments. For instance, in the process of FIGS. 7, 9, 11, it is determined whether the subject vehicle has passed through the intersection. When it is determined that the subject vehicle has passed, the transmission cycle may be returned to the previous or original value.

In addition, at S180, it may be determined whether the subject vehicle has passed through the intersection in the process of S180 based on the map information and the present position of the subject vehicle. For example, when it is determined that the subject vehicle came out of the predetermined range from the intersection the subject vehicle has been approaching, the vehicle is determined to be having passed through the relevant intersection. When it is determined that the subject vehicle did not come out of the predetermined range, the vehicle is determined to be having not passed through the relevant intersection. In addition, when the vehicle runs away from the intersection, for example, more than a predetermined distance, it may be determined that the vehicle has passed through the intersection, without using map information.

Each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As an aspect of the disclosure, a vehicle-to-vehicle communications apparatus in a first vehicle is provided as follows. The apparatus is cooperative with another vehicle-to-vehicle communications apparatus in another vehicle. The vehicle-to-vehicle apparatus comprises the following: a transmission section configured to transmit information about the first vehicle to a second vehicle at a periphery of the first vehicle; a reception section configured to receive information about the second vehicle transmitted from the second vehicle; a transmission control section configured to control the transmission section; a first-vehicle approach intersection acquisition section configured to acquire first information on a nearest intersection from the first vehicle among intersections which exist in a heading direction of the first vehicle; a second-vehicle approach intersection acquisition section configured to acquire second information on a nearest intersection from the second vehicle among intersections which exist in a heading direction of the second vehicle from the information about the second vehicle received by the reception section; and a determination section configured to determine whether information about an identical intersection is included in the first information and the second information. Herein, the transmission control section is further configured to cause the transmission section to transmit information (i) with a cycle shorter than a predetermined cycle when it is determined that the information about the identical intersection is included and (ii) with a cycle longer than the predetermined cycle when it is determined that the information about the identical intersection is not included.

When two or more vehicles approach the same intersection, the states of other peripheral vehicles should be recognized between the vehicles more correctly in order to avoid danger. Further, the existence of other vehicles should be recognized early. For example, all or some of the vehicles may run temporarily at a low speed. Even in such a case, the mutual states of the vehicles should be desirably recognized as early as possible and as accurately as possible.

According to the above aspect of the vehicle-to-vehicle communications apparatus, on the assumption that two or more vehicles are approaching the same intersection, the transmission cycle in the vehicle-to-vehicle communications apparatus of each vehicle is shorter than the predetermined cycle regardless of the speeds of the vehicles. Accordingly, in each of the vehicles, the state of the peripheral vehicle(s) can be recognized with shorter time cycles. Accordingly, the state(s) of the peripheral vehicle(s) can be more correctly grasped now. In addition, the above configuration can provide an effect that the subject vehicle is enabled to recognize the existence of the peripheral vehicle(s) more certainly at an early stage. Thus, the safety improves more.

In contrast, only one vehicle may approach the intersection. In such a case, the transmission cycle of the information on vehicle is longer than the predetermined cycle. The information on vehicle can be prevented from being transmitted unnecessarily.

In addition, many vehicles may run near the same intersection. Such a case may involve congestion of the communications traffics undesirably. Herein, most of the vehicles may get away from the intersection. In such a case, the transmission cycle of the information is lengthened in the vehicle-to-vehicle communications apparatus of each of the vehicles. Accordingly, it is avoidable that the communications traffics are crowded near the intersection.

As such, the transmission cycle of the information is determined based on not only the state of the subject vehicle, i.e., the state of the heading direction of the subject vehicle, but also the state of the peripheral vehicle, i.e., the state of the heading direction of the peripheral vehicle. It is thus effective.

As an optional aspect, the vehicle-to-vehicle communications apparatus may further include a transmission cycle calculation section configured to calculate a transmission cycle to shorten a cycle as a speed of the first vehicle increases. Herein, the transmission control section may cause the transmission section to transmit information with a cycle calculated by the transmission cycle calculation section when it is determined that the information about the identical intersection is included.

The technology of shortening the transmission cycle of the information as the speed of the subject vehicle increases is widely known in the vehicle-to-vehicle communications apparatus. Further, such a technology is specified as a standard or requirement in recent years. The vehicle-to-vehicle communications apparatus according to the above optional aspect effectively uses such a known technology, providing an effect.

Since the existing technology, i.e., the existing vehicle-to-vehicle communications apparatus, can be used, flexibility improves. For example, the existing configuration, software, etc. can be used; thus, the costs, such as development costs, can be held down.

As an optional aspect, the transmission control section may cause the transmission section to transmit information with a cycle calculated by the transmission cycle calculation section when the speed of the first vehicle is equal to or less than the predetermined speed when it is determined that the information about the identical intersection is not included.

Similarly, the vehicle-to-vehicle communications apparatus according to the above optional aspect effectively uses such a known technology, providing an effect. Similarly, the effect that flexibility improves can be acquired.

As an optional aspect, the vehicle-to-vehicle communications apparatus may further include a transmission cycle calculation section configured to calculate a transmission cycle to shorten a cycle as a speed of the first vehicle increases. Herein, the transmission control section may cause the transmission section to transmit information with a cycle calculated by the transmission cycle calculation section when the speed of the first vehicle is equal to or less than a predetermined speed when it is determined that the information about the identical intersection is not included.

Similarly, the vehicle-to-vehicle communications apparatus according to the above optional aspect effectively uses such a known technology, providing an effect.

As an optional aspect, the transmission control section may cause the transmission section to transmit information with a cycle calculated by the transmission cycle calculation section when an intersection, which is nearest to the first vehicle among intersections existing in the heading direction of the first vehicle, is not included within a predetermined range from the first vehicle.

When the transmission cycle of the information is defined based on only the speed of the vehicle near the intersection, inconvenience may arise. In contrast, if the intersection is not present in vicinity, defining the transmission cycle of the information based on only the speed of the vehicle does not provide inconvenience necessarily. Communications between more vehicles can be attained because the transmission frequency becomes low when the vehicle runs at a low speed. This can provide an effect that the required transmission frequency is secured, providing convenience.

In the vehicle-to-vehicle communications apparatus according to the above optional aspect, when the subject vehicle is not present within a predetermined range from the nearest intersection, the transmission frequency of the information is high (the transmission cycle is short) as the speed of the subject vehicle is high. In contrast, the transmission frequency becomes low (the transmission cycle is long) as the speed of the subject vehicle is small. This can provide convenience.

It will be obvious to those skilled in the art that various changes may be made in the above-described embodiments of the present invention. However, the scope of the present invention should be determined by the following claims.

What is claimed is:

1. A vehicle-to-vehicle communications apparatus in a first vehicle, the apparatus being cooperative with another vehicle-to-vehicle communications apparatus in another vehicle, the vehicle-to-vehicle apparatus comprising:
a transmission section configured to transmit information about the first vehicle to a second vehicle at a periphery of the first vehicle;
a reception section configured to receive information about the second vehicle transmitted from the second vehicle;
a transmission control section configured to control the transmission section;
a first-vehicle approach intersection acquisition section configured to acquire first information on a nearest intersection from the first vehicle among intersections which exist in a heading direction of the first vehicle;
a second-vehicle approach intersection acquisition section configured to acquire second information on a nearest intersection from the second vehicle among intersections which exist in a heading direction of the second vehicle from the information about the second vehicle received by the reception section; and
a determination section configured to determine whether information about an identical intersection is included in the first information and the second information,
the transmission control section causing the transmission section to transmit information
(i) with a cycle shorter than a predetermined cycle when it is determined that the information about the identical intersection is included and
(ii) with a cycle longer than the predetermined cycle when it is determined that the information about the identical intersection is not included.

2. The vehicle-to-vehicle communications apparatus according to claim 1, further comprising:
a transmission cycle calculation section configured to calculate a transmission cycle to shorten a cycle as a speed of the first vehicle increases,
the transmission control section causing the transmission section to transmit information with a cycle calculated by the transmission cycle calculation section when it is determined that the information about the identical intersection is included.

3. The vehicle-to-vehicle communications apparatus according to claim 2, the transmission control section causing the transmission section to transmit information with a cycle calculated by the transmission cycle calculation section when the speed of the first vehicle is equal to or less than the predetermined speed when it is determined that the information about the identical intersection is not included.

4. The vehicle-to-vehicle communications apparatus according to claim 1, further comprising:
a transmission cycle calculation section configured to calculate a transmission cycle to shorten a cycle as a speed of the first vehicle increases,
the transmission control section causing the transmission section to transmit information with a cycle calculated by the transmission cycle calculation section when the speed of the first vehicle is equal to or less than a predetermined speed when it is determined that the information about the identical intersection is not included.

5. The vehicle-to-vehicle communications apparatus according to claim 2,
the transmission control section causing the transmission section to transmit information with a cycle calculated by the transmission cycle calculation section when an intersection, which is nearest to the first vehicle among intersections existing in the heading direction of the first vehicle, is not included within a predetermined range from the first vehicle.

6. The vehicle-to-vehicle communications apparatus according to claim 4,
the transmission control section causing the transmission section to transmit information with a cycle calculated by the transmission cycle calculation section when an intersection, which is nearest to the first vehicle among intersections existing in the heading direction of the first vehicle, is not included within a predetermined range from the first vehicle.
